(19) United States
(12) Patent Application Publication
(10) Pub. No.: US 2006/0147741 A1
(43) Pub. Date: Jul. 6, 2006

(54) Composite plate device for thermal transpiration micropump

(75) Inventors: Chien-Hung Ho, Hsinchu City (TW); Sheng-Yuan Chen, Hsin-Chu City (TW); Hsuan-Hsiu Hsu, Taipei City (TW); Jing-Tang Yang, Hsinchu City (TW); Chiko Chen, Taoyuan County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: INSTRUMENT TECHNOLOGY RESEARCH CENTER, Hsin-Chu City (TW)

(21) Appl. No.: 11/302,818

(22) Filed: Dec. 14, 2005

(30) Foreign Application Priority Data
Dec. 30, 2004 (TW) 093141533

(51) Int. Cl. B22D 7/00; B32B 3/10

(52) U.S. Cl. 428/544; 428/137

(57) ABSTRACT

The present invention provides a composite plate device for a thermal transpiration micropump apparatus. The provided composite plate device includes a substrate having a plurality of flow channels and a plurality of templates with closed sidewalls, wherein the plurality of flow channels allow fluid to flow therethrough and have a feature length larger than or equal to the mean free path length of the fluid. The provided composite plate device further includes a porous material that is filled in the plurality of templates of the substrate, wherein the porous material allows the fluid to flow therethrough and has an equivalent pore diameter smaller than or equal to the mean free path length of the fluid.

### FIELD OF THE INVENTION

The present invention relates to a micropump apparatus, and more particularly, to a composite plate device included in the micropump apparatus adopting a thermal transpiration effect to drive gas to flow.

### BACKGROUND OF THE INVENTION

As the process technologies of integrated circuit (IC) and micro-electrical-mechanical system (MEMS) are continually progressing and developing, the critical objectives that cannot be achieved or fulfilled by a traditional precision machining may be implemented in the future. In recent years, engineers, who are responsible for instrument development, make an attempt aggressively to miniaturize the respectively accessory components in the instrumental equipment by utilizing these advanced fabrication techniques in order to increase functional operations of the instrument or to conform with a constraint on the volume and weight of structural space, and meanwhile to reduce production costs. For example, for the purpose of performing material prospect and composition acquisition in space with the analysis instruments, such as mass spectrometer and gas chromatograph, which may operate in the low-pressure environment, a large-scale vacuum pump must be replaced by a miniature device to reduce the overall volume of the system. Currently, a thermal transpiration micropump (i.e. the so-called Knudsen pump) apparatus is expected to satisfy the requirement of the desired vacuum environment for these analysis instruments.

Typically, the thermal transpiration pump is an apparatus for fluid drawing according to the physical effect of thermal transpiration. There are some experimental analysis and theoretical derivation provided for the thermal transpiration. The phenomenon is described as that when temperature gradient is distributed along the longitudinal direction of refinement tubes (the smaller pore diameter the tube is provided with, the more probability the fluid molecules have for a collision with the sidewall of the tube than with each other), it will drive the interior fluid to flow through themselves and then induces a pressure difference between both ends of the tube. Under ideal conditions, the relationship between the pressure and the temperature is provided as follows:

$$\frac{{P}_{1}}{{P}_{2}} = \frac{\sqrt{{T}_{1}}}{\sqrt{{T}_{2}}}$$

where P₁, T₁, P₂ and T₂ express the pressure of chambers and the absolute temperature on both ends of the tube respectively. As shown in FIG. 1, is a schematic diagram showing one stage of the first multi-staged serial thermal transpiration pump according to the prior art. Due to the limitation on the process capability, however, the dimension of the tube would fail to reach a micro-scale or even a nano-scale level in diameter. This thermal transpiration apparatus therefore showed a very low degree of thermal efficiency and pumping rate. Nowadays these problems can be effectively solved through the application of MEMS technology.

FIG. 2 is a schematic diagram that illustrates an embodiment of a conventional device design by using typical micromachined technology to fabricate multi-staged thermal transpiration pump apparatuses 200 in series. In FIG. 2, the thermal transpiration pump 200 comprises a semiconductor substrate 210 and a heating mechanism 280, where the semiconductor substrate 210 has a plurality of flow chambers 262 and a plurality of flow tubes 230, and where the plurality of flow tubes 230 may be porous material films. In this embodiment, by using the heating mechanism 280, the pump apparatus 200 may generate a temperature difference between both ends of the thin-filmed porous material that separates one flow chamber from the other. Based on the temperature difference, fluid can be driven to flow through the thin-filmed porous material, and the desired pressure difference is therefore induced between the flow chambers 262. However, the structures with flow chambers and flow tubes (or thin-filmed porous materials) disposed together in a single semiconductor substrate are hardly to be achieved. The device may need very complicated fabrication processes associated with presently developed micromachining techniques. More particularly, many compatible problems, such as the etching selectivity of materials, generated in the fabrication processes should be overcome previously if a heating mechanism needs to be integrated into the flow chamber, or if a suspended structure 282 is even used for supporting the heating mechanism.

In another conventional embodiment, the porous material utilized for a thermal transpiration pump is disposed between two material layers with better thermal conductivity to achieve the implementation of the apparatus. As shown in FIG. 3, the thermal transpiration pump 300 comprises a first thermal guard 340 and a second thermal guard 350 that have holes 342, 352, respectively, for allowing gas to flow therethrough, a porous material 330 disposed between the thermal guards 340, 350 and a heating mechanism 380 for maintain a temperature difference between the first thermal guard 340 and the second thermal guard 350. The required heat energy generated by the heating mechanism 380 to form the temperature difference in the porous material 330 is conducted first to the first and the second thermal guards 340, 350, and then is propagated to the porous material 330 through the first and the second thermal guards 340, 350. In order to achieve good heat transfer performance, low thermal contact resistance is preferably provided between the porous material and the thermal guard layers to reduce the obstruction of heat transfer with each other and to maintain a specific temperature difference on the two side of this porous layer. For the purpose of low thermal contact resistance, in addition to the selection of materials with high thermal conductivity (e.g. silicon that is suitable for a micromachining process), the surfaces of the porous material and the thermal guard layers should be as close as possible or even directly contact together on assembled positions. However, currently an obtainable porous material, such as aerogel and photopolymer, cannot be really synthesized with substantially large contact area since there are many pores in its structural frames. Therefore, the thermal contact resistance will be increased when it is disposed between the thermal guard layers. Furthermore, in consideration of low structural strength and brittle or soft texture, the porous material may tend to be cracked due to excessive high contact stress on the interface with the thermal guard layers after subsequently pressed and airtight package process.

In another embodiment, which is similar to that in FIG. 2, the components of a thermal transpiration apparatus are integrated into a plurality of substrates. As shown in FIG. 4, the thermal transpiration pump 400 comprises a substrate 420 with an inner surface, a substrate cover 460 with inner and outer surfaces and at least one micromachined layer 410 located between the inner surfaces. When the substrate 420 and the substrate cover 460 are bonded together, the micromachined layer 410 of the inner surface will form a desired micromachining device, which includes at least one narrow microfluidic channel 430, for example. According to the conventional principle of thermal transpiration, the feature size of narrow microfluidic channels (narrow tubes) is related to the mean free path length of the working fluid used in the thermal transpiration pump. For example, the mean free path of an atmospheric molecule is about 100 nanometers (nm) in scale at normal temperature and pressure conditions. In order to achieve a good effect of thermal transpiration in an ambient environment, the diameter of narrow tubes is required to be less than 100 nm such that this apparatus may exhibit better performance in fluidic extraction or compression. Based on the well-matured micromachining technologies, it is undoubtedly a very difficult undertaking for the manufacturing of the narrow tubes with nano scale in diameter and high aspect ratio. In this embodiment, the feature size of the plurality of narrow tubes 430 is defined through the micrormachined layer 410 by thin film etching and deposition, for example. However, the subsequent process step in the substrate and the final bonding procedure between the substrate 420 and the substrate cover 460 may cause an error in precision in the narrow tubes 430, and even obturate the pore diameter to result in a failure in operation.

Therefore, according to the possible drawbacks disclosed in the above-mentioned embodiments, there is a great demand for developing a novel and simple process method to fabricate a thermal transpiration pump apparatus with high yield, high efficiency and high reliability.

### SUMMARY OF THE INVENTION

To solve the aforementioned problems, a novel device design is proposed in the present invention based on the formation of a porous material filled into a given template to implement a thermal transpiration pump apparatus. The provided device has the advantage of simple fabrication and is easy for processing and assembling.

The aspect of the present invention is provided with a composite plate device that includes a substrate and a porous material for a thermal transpiration pump. The substrate has a plurality of flow channels and a plurality of templates with closed sidewalls, and the porous material is filled into the plurality of templates of the substrate.

Another aspect of the present invention is provided with a composite plate device that comprises a substrate, a first thermal conductive layer, a second thermal conductive layer and a porous material. Wherein the substrate has a plurality of flow channels and a plurality of templates with closed sidewalls; the first thermal conductive layer is disposed above the substrate and has a plurality of flow channels and a plurality of templates with closed sidewalls; the second thermal conductive layer is disposed below the substrate and has a plurality of flow channels and a plurality of templates with closed sidewalls, and the porous material is filled into the plurality of templates of the substrate, the first thermal conductive layer and the second thermal conductive layer, respectively.

The other aspects, features and advantages of the present invention will be apparent through the following detailed description of the preferred embodiments. However, it should be understood that the detailed description and the specific embodiments are exemplary illustration only and various modifications, equivalents and replacements may be performed without departing from the field of the claim of the present invention.

The foregoing and other features and advantages of the present invention will be more clearly understood through the following descriptions with reference to the drawings, wherein:

### BRIEF DESCRIPTION OF THE DRAWINGS

FIG. 1 is a schematic diagram showing one stage of the first multi-staged serial thermal transpiration pump according to the prior art;

FIG. 2 is a schematic diagram showing a conventional apparatus design where a typical micromachined technology is adopted to fabricate a multistage thermal transpiration pump apparatus in series therefor according to the prior art;

FIG. 3 is a schematic diagram of a simplified exploded cross section showing an arrangement of a conventional single stage thermal transpiration pump according to the prior art, wherein a porous material is disposed between two layers of thermal conductive materials to implement the apparatus;

FIG. 4 is a schematic diagram showing a thermal transpiration pump with a hot chamber and a cold chamber connected with each other through refinement tubes (narrow microfluidic channels) formed by using a conventional package and bonding techniques according to the prior art;

FIG. 5 is a top view of a composite plate device for a thermal transpiration pump in accordance with an embodiment of the present invention;

FIG. 6 is a top view of a composite plate device applied to a thermal transpiration pump that includes a plurality of baffle through holes in accordance with another embodiment of the present invention;

FIG. 7a is a top view of a composite plate device for a thermal transpiration pump in accordance with another embodiment of the present invention;

FIG. 7b is a sided cross section showing a composite plate device for a thermal transpiration pump along an A-A segment in accordance with an embodiment of the present invention in FIG. 7a;

FIG. 7c is a sided cross section showing a composite plate device for a thermal transpiration pump along a B-B segment in accordance with an embodiment of the present invention in FIG. 7a;

FIG. 8a is a top view of a composite plate device for a thermal transpiration pump in accordance with another embodiment of the present invention;

FIG. 8b is a sided cross section showing a composite plate device for a thermal transpiration pump along an A-A segment in accordance with an embodiment of the present invention in FIG. 8a;

FIG. 8c is a sided cross section showing a composite plate device for a thermal transpiration pump along a B-B segment in accordance with an embodiment of the present invention in FIG. 8a;

FIG. 9 is a schematic diagram showing one of the preferred embodiments for the implementation of a thermal transpiration pump apparatus associated with the composite plate device in accordance with the present invention; and

FIG. 10 is a schematic diagram showing another preferred embodiment for the implementation of a thermal transpiration pump apparatus associated with the composite plate device in accordance with the present invention.

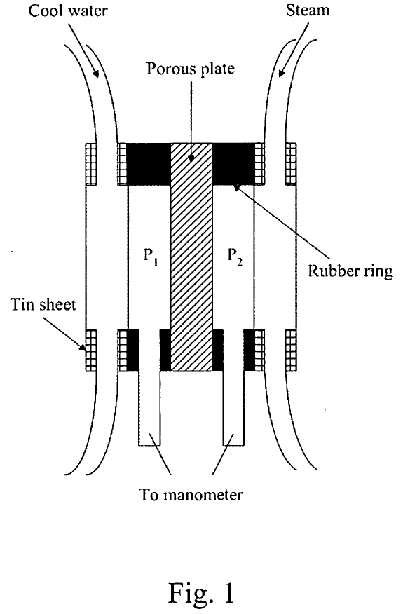

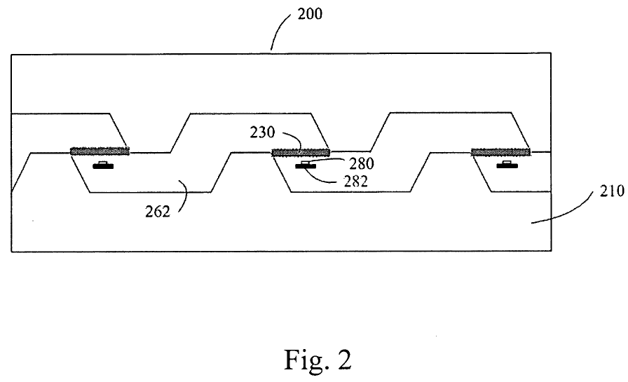

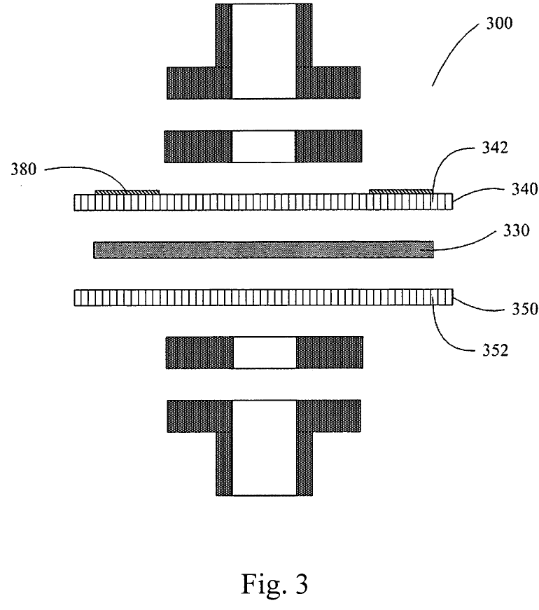

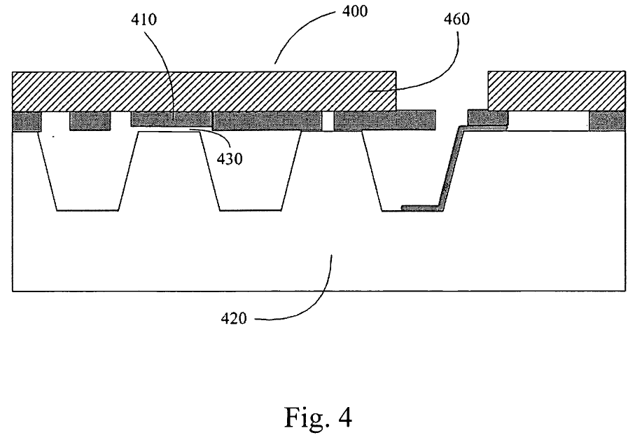

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

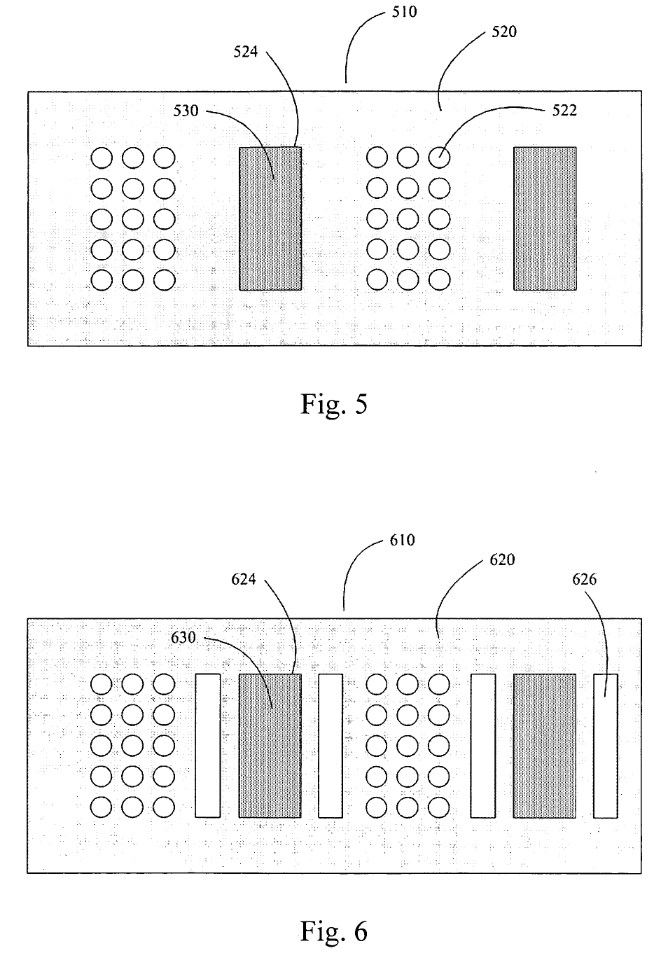

FIG. 5 is a top view of a composite plate device 510 for a thermal transpiration pump in accordance with an embodiment of the present invention. The composite plate device 510 comprises a substrate 520 having a plurality of flow channels 522 and a plurality of templates 524 with closed sidewalls, and a porous material 530 filled into the plurality of templates 524 of the substrate 530. The plurality of flow channels 522 of the substrate 520 allow fluid to flow therethrough and have feature length themselves larger than or equal to the mean free path length of the fluid. For example, at normal temperature and pressure, if the mean free path length of atmospheric molecules is about 100 nm, the pore diameter of the flow channels can be 10 μm above. Therefore, the Knudsen number (i.e. Kn=λ/d, wherein Kn is the Knudsen number, λ is the mean free path length of the fluid and d is the hydraulic diameter of the flow channels), which is used to define the flow state of fluid, is less than 0.01 to ensure that the atmospheric molecules in the flow channels fall within the continuum flow regime (i.e. the viscous flow regime). In addition, the porous material 530 allows the fluid to flow therethrough and has an equivalent pore diameter itself smaller than or equal to the mean free path length of the fluid. For example, at normal temperature and pressure, if the mean free path length of atmospheric molecules is about 100 nm, the equivalent pore diameter of the flow channels can be 100 nm below. Therefore, the Knudsen number is more than 1 to ensure that the atmospheric molecules in the porous material fall within the free molecular flow regime.

In one embodiment of the present invention, the substrate 520 of the composite plate device 510 may be chosen from semiconductor materials, such as silicon and glass substrates, which are well known and readily available. However, it will be appreciated by those skilled in the art that other suitable materials, such as ceramic, polymeric and electroplated metallic materials, may be chosen as the substrate 520 used for the implementation of the present invention.

In one embodiment of the present invention, the cross section of the plurality of flow channels 522 and the plurality of templates 524 of the substrate 520 may be designed as circular or rectangular. However, other shapes, such as ellipse, may be used, which primarily depends upon the requirement on the design.

Currently, ultra high-aspect-ratio (i.e. larger than 100) narrow tubes (narrow microfluidic channels) cannot be effectively achieved because of the limitation of process capability in the conventional manufacturing technologies, for example, an aspect ratio of 5000 for the narrow tubes of 500 μm in height and 100 nm in pore diameter. In the present embodiment, therefore, a porous material may be utilized as a penetrable membrane for the thermal transpiration pump. Since fluid has corresponsive mean free path length λ at various pressure conditions, the required hydraulic diameters d of the narrow tubes depend on this constraint. In one embodiment of the present invention, aerogel or photopolymer may be used as a porous material filled into the template cavities of the substrate. However, other stack spherical particles may be used to form micro pores, which can generate desired pore diameters specifically. For example, conventional silica aerogel may be synthesized by continued hydrolysis and condensation reactions through a combination of tetraethoxysilane (TEOS) and water in ethyl alcohol solution. It will be appreciated by those skilled in the art that the samples of desired porous materials may be prepared by using other related chemical reagents, such as alkoxide, organic salt, inorganic salt, metal oxide, etc. The synthetic silica aerogel may have an averaged pore diameter of about 20 μm and a porosity of approximate 95%, and have low thermal conductivity of about 15-17 mW/mK at normal pressure. Therefore, such a material may be applicable to the operation of the thermal transpiration pump at atmospheric pressure according to the physical properties of the silica aerogel. Furthermore, conventional photopolymer is prepared as a mixture in advance through an addition of ethylene glycol dimethacrylate (EDMA) monomer solution to azobisisobutyronitrile (AIBN), and then can be formed by light source irradiation with a specific wavelength in which a photoinitiator may generates free radicals to induce a series of polymeric reactions. It will be appreciated by those skilled in the art that other chemical reagents may be used as monomers, such as methacrylate, acrylamide, styrene and acrylate, or as photoinitiators, such as azo group and acetophenone, respectively, to prepare the desired samples of porous materials. The synthetic photopolymer may have an averaged pore diameter of about 0.05-10 μm and a porosity of approximate 50%, and have low thermal conductivity of about 1 to 10 mW/mK at normal pressure. Therefore, such a material may be applicable to the operation of the thermal transpiration pump in a relatively high vacuum environment (10 Torr below, for example) according to the physical properties of the photopolymer.

In another embodiment of the present invention, the substrate 620 of a composite plate device 610 further has a plurality of baffle through holes 626 disposed on both sides of the templates 624, which is filled with a porous material 630. As shown in FIG. 6, it is a top view of the composite plate device 610 with the plurality of baffle through holes 626 included in the thermal transpiration pump in accordance with the embodiment of the present invention. In order to obtain better performance in heat exchange between fluid and the hot or cold areas of the thermal transpiration pump such that the fluid may preferably reach a desired temperature before flowing into the porous material 630, the baffle through holes 626 are disposed in order that baffles (not shown) may pass therethrough to guide the fluid to flow along a desired direction. In an embodiment of the present invention, the cross section of the plurality of baffle through holes 626 may be designed with a rectangular shape to fit the configuration of a baffle structure. However, other shapes of the baffle through holes 626, which are capable of adapting to the baffle structures, may also be utilized, depending on the required conditions.

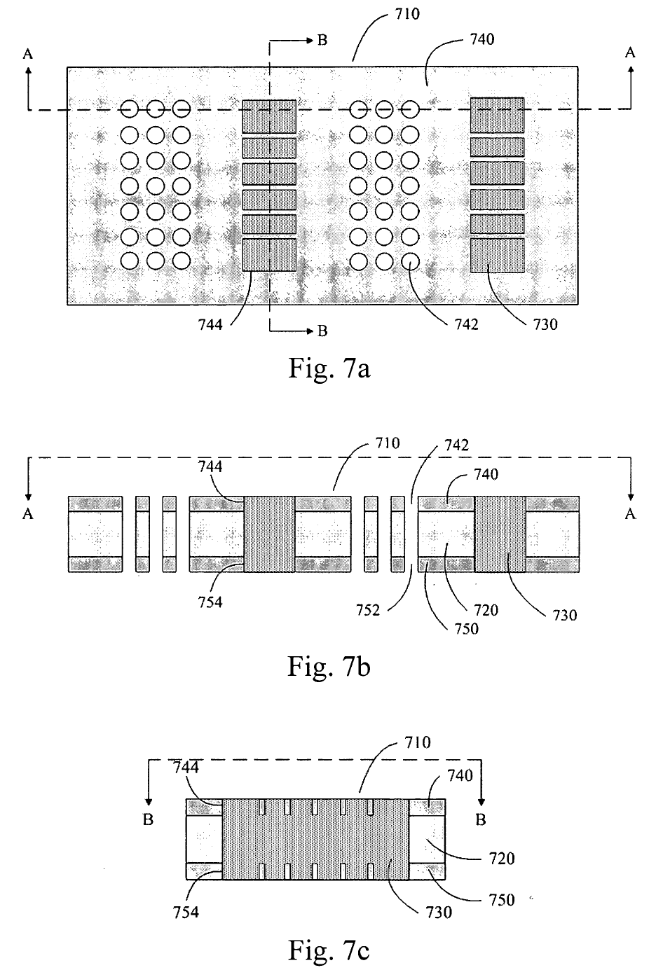

In another embodiment of the present invention, a composite plate device 710 further comprises a first thermal conductive layer 740 disposed above the substrate 720 and a second thermal conductive layer 750 disposed under the substrate 720. As shown in FIG. 7a, it is a top view of the composite plate device 710 for a thermal transpiration pump according to the embodiment of the present invention. The thermal conductive layers 740, 750 further contain a plurality of flow channels 742, 752 and a plurality of templates 744, 754 with closed sidewalls, and wherein the plurality of flow channels 742, 752 allow fluid to flow therethrough and have feature length themselves larger than or equal to the mean free path length of the fluid. Referring to FIG. 7b and FIG. 7c, wherein FIG. 7b is a sided cross section showing the composite plate device 710 for a thermal transpiration pump along an A-A segment according to the embodiment of the present invention in FIG. 7a and FIG. 7c is a sided cross section showing the composite plate device 710 for a thermal transpiration pump along an B-B segment according to the embodiment of the present invention in FIG. 7a. In order to generate a uniform temperature distribution on the upper and lower surfaces of the porous material 730 filled into the substrate 720 of the composite plate device 710 (e.g. one surface of the porous material 730 approximates to the temperature of a hot source, whereas the other approximates to the temperature of a cold source) as well as to form a desired temperature gradient along the thickness direction of the porous material 730 (since the thermal transpiration effect results from the temperature gradient exerted between the surfaces of the porous material.), in the embodiment of the present invention, thermal conductive layers 740, 750 are therefore provided to achieve the above purpose. The function of the thermal conductive layers 740, 750 emphasizes the provision of complete infilling for the porous material 730 in the templates 744, 754 thereof, and therefore, there are excellent and tight contact interfaces between the thermal conductive layers 740, 750 and the porous material 730 to increase the thermal conductivity and decrease the thermal contact resistance thereof. Another function of the thermal conductive layers 740, 750 is to provide adequately for the heat exchange (e.g. through molecule collision to induce heat conduction) between the layers themselves and fluid molecules before entering the porous material 730. By this heat exchange, the fluid molecules may adjust their temperature to approximate to those of the porous material 730, and therefore, the temperature equalization for the fluid and the porous material 730 will be able to enhance the performance of the thermal transpiration effect. According to one embodiment of the present invention, the thermal conductive layers 740, 750 may be selected from the materials that are easy to be processed and have high thermal conductivity, such as silicon, ceramics and electroplating metals. It will be appreciated that other materials with high thermal conductivity may be used, depending on the requirement, and these should not be limited by the claim of the present invention. Furthermore, as shown in FIG. 7a, according to the embodiment of the present invention, the templates 744, 754 of the thermal conductive layers 740, 750 may be provided with a fence-like structural design, which can improve the thermal conductivity among the substrate 720, the fluid and the porous material 730. Other structural designs capable of enhancing the thermal conductivity, such as comb-like, fin-like and other structures, may be fabricated in accordance with a particular requirement, and these should not be limited by the claim of the present invention.

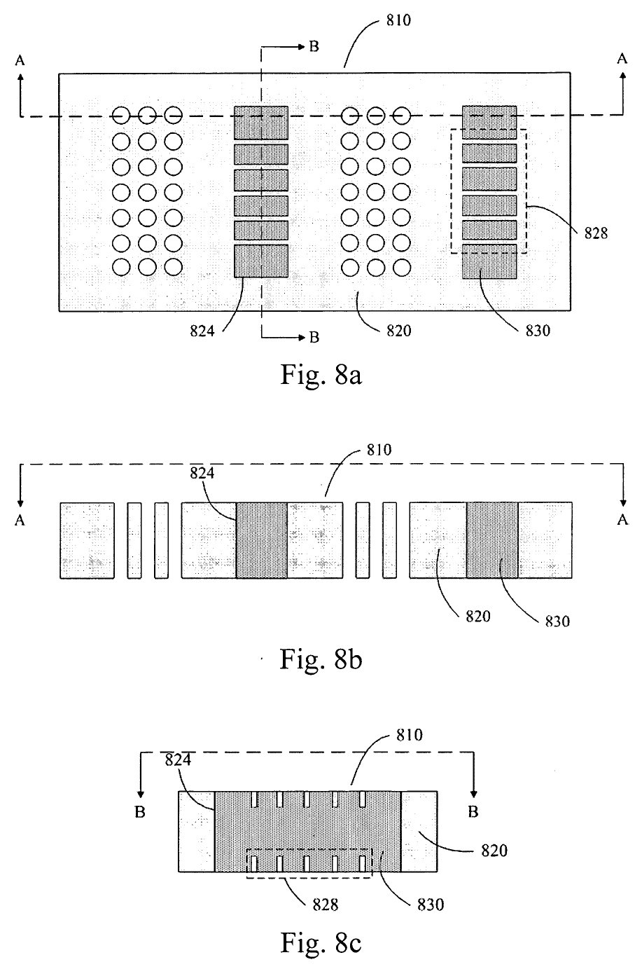

Furthermore, referring to FIG. 8a, this diagram shows a top view of a composite plate device 810 for a thermal transpiration pump according to another embodiment of the present invention. In the embodiment of the present invention, the templates 824 in the substrate 820 of a composite plate device 810 further have a design with fence-like structures 828 for increasing the thermal conductivity among the substrate 820, fluid and a porous material 830. For example, a silicon-on-insulator (SOI) wafer, which is popularly used in semiconductor industry, may be chosen as the substrate 820 to fabricate the templates 824 with the fence-like structures 828 by a conventional selective etching method. Referring to FIG. 8b and FIG. 8c, wherein FIG. 8b is a sided cross section showing the composite plate device 810 for a thermal transpiration pump along an A-A segment according to the embodiment of the present invention in FIG. 8a and FIG. 8c is a sided cross section showing the composite plate device 810 for a thermal transpiration pump along an B-B segment according to the embodiment of the present invention in FIG. 8a. Other structural designs capable of enhancing the thermal conductivity, such as comb-like, fin-like and other structures, may be fabricated in accordance with a particular requirement, and these should not be limited by the claim of the present invention.

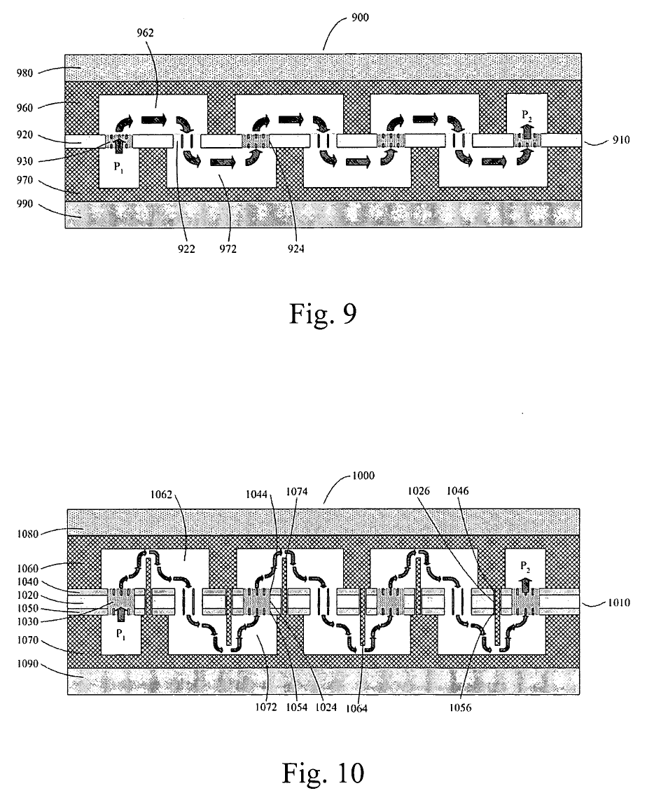

The following description will illustrate in detail one embodiment of the multi-staged serial thermal transpiration pump apparatus by using other related components associated with the composite plate device in the present invention to distinctly express the overall realization of the composite plate device in the present invention. FIG. 9 is a schematic diagram showing one of the preferred embodiments for the implementation of a thermal transpiration pump apparatus 900 associated with the composite plate device in accordance with the present invention. The thermal transpiration pump 900 comprises a composite plate device 910 with a substrate 920 and a porous material 930, a first seal layer 960 and a second seal layer 970 with a plurality of chambers 962, 972 displaced on both sides of the composite plate device 910 and a heating source 980 and a cooling source 990 displaced on the opposite surfaces of the first seal layer 960 and the second seal layer 970, respectively. In operation, when the heating source 980 and the cooling source 990 are activated, the chambers 962, 972 of the first seal layer 960 and the second seal layer 970 may have a specific temperature difference formed between themselves due to heat transfer from the heating source 980 and the cooling source 990. Heat energy is transferred through the contact between the seal layers 960, 970 and the substrate 920, and a temperature gradient is then generated and distributed across both sides of the porous material 930 embedded in the composite plate device 910. Following the arrow indication shown in FIG. 9, the working fluid in the continuum flow mode flows from the chamber 962 of the first seal layer 960 to the chamber 972 of the second seal layer 970 via the substrate 920 of the composite plate device 910. Meanwhile the working fluid in the free molecular flow mode flows from the chamber 972 of the second seal layer 970 to the chamber 962 of the first seal layer 960 via the porous material 930 of the composite plate device 910. The multistage cascade effect of the thermal transpiration pump apparatus 900 will generate a significant pressure difference between the first end (i.e. which is indicated with P1) and the second end (i.e. which is indicated with P2) of the chambers 972, 962, respectively. In fabrication, the composite plate device 910 may be previously patterned on the substrate 920 by using conventional techniques, including anisotropic etching, electroplating or mold forming, to defined a plurality of flow channels 922 and a plurality of templates 924 with closed sidewalls, and then may be formed by filling the porous material 930 into the templates 924 of the substrate 920. In another embodiment, the template 924 of the substrate 920 are further provided with a structural design (referring to FIG. 8a and FIG. 8c), such as fence-like, comb-like and fin-like structures, for upgrading thermal conductivity so that the heat transfer efficiency can be improved among the substrate 920, the fluid and the porous material 930. The first seal layer 960 and the second seal layer 970 having the plurality of chambers 962, 972 may also be implemented by using conventional techniques, including anisotropic etching, electroplating, mold forming, etc. The heating source 980 and the cooling source 990 may be selected from chemical materials with high energy density, such as a Calcium oxide (CaO) substrate for the heating source and an Ammonium Nitrate (NH₄NO₃) substrate for the cooling source. Because of the high and low temperature difference generated by exothermic and endothermic mechanisms through CaO and NH₄NO₃ that, for example, are reacted with water, in the embodiment of the present invention water may be adopted as an excited source for the temperature difference to actuate the thermal transpiration pump apparatus 900. Furthermore, in addition to chemical actuation, the present invention may use other heating or cooling devices, such as infrared radiation, electronic planar coils, thermoelectric Coolers and fins, to achieve the purpose of the high and low temperature difference between both sides of the composite plate 910. In assembly, the composite plate device 910, the first seal layer 960, the second seal layer 970, the heating source 980 and the cooling source 990 may be superimposed on one another in the embodiment of the present invention. It will be appreciated by those skilled in the art that various conventional bonding technologies, such as adhesive bonding, anodic bonding, low-temperature local bonding and press forming, may be used depending on different requirements considered from material characteristics, interface gas tightness and thermal conductivity, and these technologies should not be included in the claim of the present invention.

FIG. 10 is a schematic diagram showing another preferred embodiment for the implementation of a thermal transpiration pump apparatus 1000 associated with the composite plate device 1010 in accordance with the present invention. The thermal transpiration pump 1000 comprises the composite plate device 1010 having a substrate 1020, a first thermal conductive layer 1040, a second thermal conductive layer 1050 and a porous material 1030, a first seal layer 1060 and a second seal layer 1070 with a plurality of chambers 1062, 1072 disposed on both sides of the composite plate device 1010, respectively, a heating source 1080 and a cooling source 1090 disposed on the opposite surfaces of the seal layers 1060, 1070. In the embodiment of the present invention, the substrate 1020, the first thermal conductive layer 1040 and the second thermal conductive layer 1050 may have a plurality of baffle through holes 1026, 1046, 1056, respectively, and the first seal layer 1060 and the second seal layer 1070 may further have a plurality of baffles 1064, 1074 to generate a better heat exchange effect between fluid and the seal layers 1060, 1070. The baffle through holes 1026, 1046, 1056 may be specifically disposed such that the baffles 1064, 1074 can be passed through the baffle through holes 1026, 1046, 1056 to guide the fluid flowing along a given direction. In the embodiment of the present invention, the structural width of the baffles 1064, 1074 may be less than that of partition walls in both chambers 1062, 1072. In the embodiment of the present invention, the templates 1044, 1054 of the first thermal conductive layer 1040 and the second thermal conductive layer 1050 is provided with a structural design for increasing heat conduction (referring to FIG. 7a and FIG. 7c), such as fence-like, comb-like and fin-like structures, and the porous material 1030 is filled into the template 1024 of the substrate 1020, the template 1044 of the first thermal conductive layer 1040 and the template 1054 of the second thermal conductive layer 1050 to increase the performance of thermal conduction among the first thermal conductive layer 1040, the second thermal conductive layer 1050, the fluid and the porous material 1030.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A composite plate device for a thermal transpiration pump, said composite plate device comprising:
a substrate having a plurality of flow channels and a plurality of templates with closed sidewalls, wherein the plurality of flow channels allow fluid to flow therethrough and have feature length themselves larger than or equal to the mean free path length of the fluid; and
a porous material filled into the plurality of templates of the substrate, wherein the porous material allows the fluid to flow therethrough and has an equivalent pore diameter itself smaller than or equal to the mean free path length of the fluid.

2. The composite plate device of claim 1, wherein the stuff of the substrate is one of a semiconductor material, a ceramic material, a polymeric material and an electroplated metallic material.

3. The composite plate device of claim 1, wherein the cross section of the plurality of flow channels comprises one of circular and rectangular shapes.

4. The composite plate device of claim 1, wherein the cross section of the plurality of templates comprises one of circular and rectangular shapes.

5. The composite plate device of claim 1, wherein the porous material is selected from one of aerogel, photopolymer and stack spherical particles.

6. The composite plate device of claim 1, wherein the substrate includes a plurality of baffle through holes, and wherein the plurality of baffle through holes are disposed such that baffles may pass therethrough to guide the fluid to flow along a desired direction.

7. The composite plate device of claim 6, wherein the cross section of the plurality of baffle through holes comprises a rectangular shape.

8. The composite plate device of claim 1, wherein the templates of the substrate further include one of fence-like, comb-like and fin-like structures to increase thermal conductivity among the substrate, the fluid and the porous material.

9. A composite plate device for a thermal transpiration pump, said composite plate device comprising:
a substrate having a plurality of flow channels and a plurality of templates with closed sidewalls, wherein the plurality of flow channels allow fluid to flow therethrough and have feature length themselves larger than or equal to the mean free path length of the fluid;
a first thermal conductive layer disposed above the substrate, wherein the first thermal conductive layer has a plurality of flow channels and a plurality of templates with closed sidewalls, and wherein the plurality of flow channels allow the fluid to flow therethrough and have feature length themselves larger than or equal to the mean free path length of the fluid;
a second thermal conductive layer disposed below the substrate, wherein the second thermal conductive layer has a plurality of flow channels and a plurality of templates with closed sidewalls, and wherein the plurality of flow channels allow the fluid to flow therethrough and have feature length themselves larger than or equal to the mean free path length of the fluid; and
a porous material filled into the plurality of templates of the substrate, the thermal conductive layer and the second thermal conductive layer, wherein the porous material allows the fluid to flow therethrough and has an equivalent pore diameter itself smaller than or equal to the mean free path length of the fluid.

10. The composite plate device of claim 9, wherein the stuff of the substrate is one of a semiconductor material, a ceramic material, a polymeric material and an electroplated metallic material.

11. The composite plate device of claim 9, wherein the stuff of the first thermal conductive layer is one of a semiconductor material, a ceramic material and an electroplated metallic material.

12. The composite plate device of claim 9, wherein the cross section of the plurality of templates of the first thermal conductive layer includes one of fence-like, comb-like and fin-like structures.

13. The composite plate device of claim 9, wherein the stuff of the second thermal conductive layer is one of a semiconductor material, a ceramic material and an electroplated metallic material.

14. The composite plate device of claim 9, wherein the cross section of the plurality of templates of the second thermal conductive layer includes one of fence-like, comb-like and fin-like structures.

15. The composite plate device of claim 9, wherein the first thermal conductive layer, the second thermal conductive layer and the substrate are bonded with one another by using a hermetic seal.

16. The composite plate device of claim 15, wherein the hermetic seal is formed by one method of anodic bonding, fusion bonding and adhesive bonding technologies.

17. The composite plate device of claim 9, wherein the porous material comprises one of aerogel, photopolymer and stack spherical particles.

18. The composite plate device of claim 9, wherein the substrate, the first thermal conductive layer and the second thermal conductive layer include a plurality of baffle through holes, respectively, and wherein the plurality of baffle through holes are disposed such that baffles may pass therethrough to guide the fluid to flow along a desired direction.

19. The composite plate device of claim 18, wherein the cross section of the plurality of baffle through holes comprises a rectangular shape.
